(19) United States
(12) Patent Application Publication
(10) Pub. No.: US 2013/0220868 A1
(43) Pub. Date: Aug. 29, 2013

(54) APPARATUS AND METHOD OF CLEANING A LAUNDRY TREATING APPLIANCE

(71) Applicant: Whirlpool Corporation, (US)

(72) Inventors: Shawn A. Armstrong, New Buffalo, MI (US); Tremitchell Wright, Elkhart, IN (US)

(73) Assignee: WHIRLPOOL CORPORATION, Benton Harbor, MI (US)

(21) Appl. No.: 13/845,832

(22) Filed: Mar. 18, 2013

Related U.S. Application Data
(62) Division of application No. 13/158,639, filed on Jun. 13, 2011.

(51) Int. Cl. B08B 1/00

(52) U.S. Cl. CPC B08B 1/001
USPC 206/524.5

(57) ABSTRACT

A treating packet for treating the inner surface of a rotatable drum in a laundry treating appliance comprises a chemical insert and a permeable pouch enveloping the chemical insert. The chemical insert in combination with the permeable pouch may apply a chemical and mechanical cleaning action sufficient to abrade a residue on the inner surface of the drum during rotation of the drum.

### CROSS-REFERENCE TO RELATED APPLICATION

This application is a divisional of U.S. patent application Ser. No. 13/158,639, filed Jun. 13, 2011, which is incorporated herein by reference in its entirety.

### BACKGROUND OF THE INVENTION

Laundry treating appliances, such as clothes washers, clothes dryers, and refreshers, may have a configuration based on a rotating drum that defines a treating chamber in which laundry items are placed for treating according to a cycle of operation. A dispensing system may be provided for dispensing a treating chemistry as part of the cycle of operation. A controller may be operably connected with the dispensing system and may have various components of the laundry treating appliance to execute the cycle of operation. The cycle of operation may be selected manually by the user or automatically based on one or more conditions determined by the controller. The dispensed treating chemistry may result in the build-up of residue on the interior surfaces defining the treating chamber, which may be visually unappealing to a user and may undesirably transfer to the laundry.

### SUMMARY

The embodiments of the invention relate to a treating packet for treating the inner surface of a rotatable drum in a laundry treating appliance comprising a chemical insert and a permeable pouch enveloping the chemical insert.

### BRIEF DESCRIPTION OF THE DRAWINGS

In the drawings:

FIG. 1 is a schematic view of a laundry treating appliance in the form of a clothes dryer according to a first embodiment of the invention.

FIG. 2 is a schematic view of a controller of the clothes dryer in FIG. 1.

FIG. 3 is a perspective view of a treating packet according to a second embodiment of the invention.

FIG. 4 is a schematic cross-sectional view of the assembled treating packet of FIG. 3 according to the second embodiment of the invention.

FIG. 5 is perspective view of a storage package for use with the treating packet of FIG. 3 according to a third embodiment of the invention.

FIG. 6 is a flow chart illustrating a method of using a treating packet according to a fourth embodiment of the invention.

FIG. 7 is a first schematic view of a drum illustrating movement of a treating packet within the drum according to a fifth embodiment of the invention.

FIG. 8 is a second schematic view of the drum of FIG. 7 illustrating movement of the treating packet within the drum according to the fifth embodiment of the invention.

FIG. 9 is a third schematic view of the drum of FIG. 7 illustrating movement of the treating packet within the drum according to the fifth embodiment of the invention.

FIG. 10 is a perspective of a treating packet according to a sixth embodiment of the invention.

FIG. 11 is a schematic cross-sectional view of the treating packet of FIG. 10 according to the sixth embodiment of the invention.

FIG. 12 is a perspective of a treating packet according to a seventh embodiment of the invention.

FIG. 13 is a schematic cross-sectional view of the treating packet of FIG. 13 according to the seventh embodiment of the invention.

### DESCRIPTION OF EMBODIMENTS OF THE INVENTION

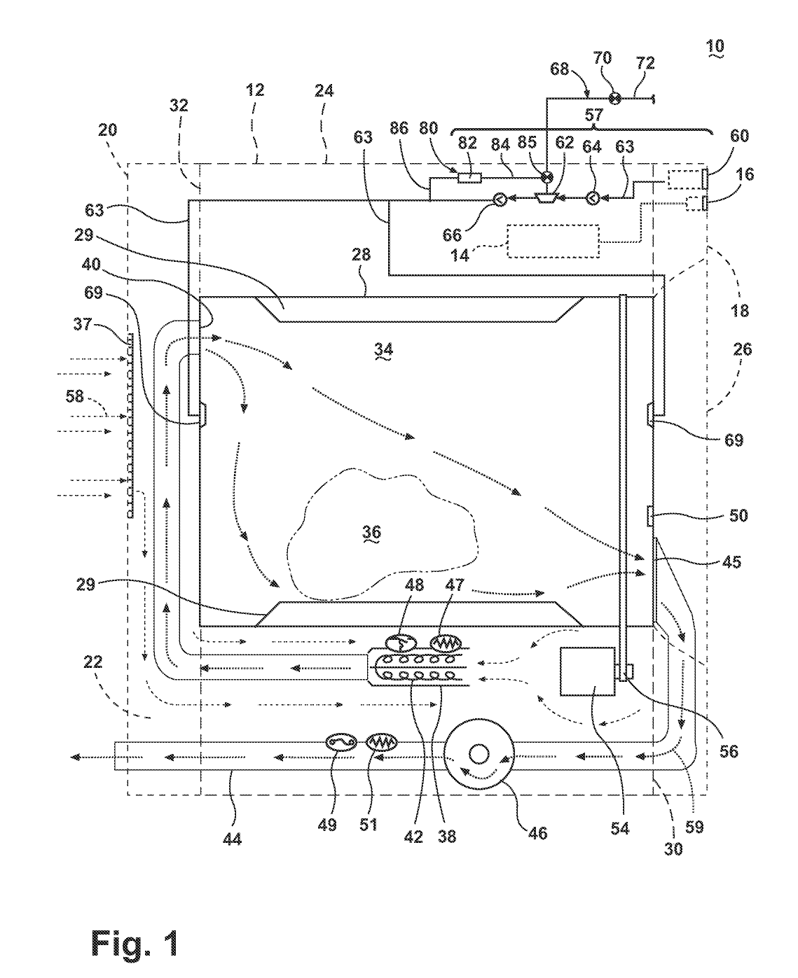

FIG. 1 is a schematic view of a laundry treating appliance 10 in the form of a clothes dryer 10 that may be controlled according to one embodiment of the invention. The clothes dryer 10 described herein shares many features of a traditional automatic clothes dryer, which will not be described in detail except as necessary for a complete understanding of the invention. While the embodiments of the invention are described in the context of a clothes dryer 10, the embodiments of the invention may be used with any type of laundry treating appliance, non-limiting examples of which include a washing machine, a combination washing machine and dryer and a refreshing/revitalizing machine.

As illustrated in FIG. 1, the clothes dryer 10 may include a cabinet 12 in which is provided a controller 14 that may receive input from a user through a user interface 16 for selecting a cycle of operation and controlling the operation of the clothes dryer 10 to implement the selected cycle of operation.

The cabinet 12 may be defined by a front wall 18, a rear wall 20, and a pair of side walls 22 supporting a top wall 24. A chassis may be provided with the walls being panels mounted to the chassis. A door 26 may be hingedly mounted to the front wall 18 and may be selectively movable between opened and closed positions to close an opening in the front wall 18, which provides access to the interior of the cabinet 12.

A rotatable drum 28 may be disposed within the interior of the cabinet 12 between opposing stationary front and rear bulkheads 30, 32, which, along with the door 26, collectively define a treating chamber 34 for treating laundry. As illustrated, and as is the case with most clothes dryers, the treating chamber 34 is not fluidly coupled to a drain. Thus, any liquid introduced into the treating chamber 34 may not be removed merely by draining

Non-limiting examples of laundry that may be treated according to a cycle of operation include, a hat, a scarf, a glove, a sweater, a blouse, a shirt, a pair of shorts, a dress, a sock, a pair of pants, a shoe, an undergarment, and a jacket. Furthermore, textile fabrics in other products, such as draperies, sheets, towels, pillows, and stuffed fabric articles (e.g., toys), may be treated in the clothes dryer 10.

The drum 28 may include at least one lifter 29. In most dryers, there may be multiple lifters. The lifters may be located along an inner surface of the drum 28 defining an interior circumference of the drum 28. The lifters may facilitate movement of the laundry 36 within the drum 28 as the drum 28 rotates.

The drum 28 may be operably coupled with a motor 54 to selectively rotate the drum 28 during a cycle of operation. The coupling of the motor 54 to the drum 28 may be direct or indirect. As illustrated, an indirect coupling may include a belt 56 coupling an output shaft of the motor 54 to a wheel/pulley on the drum 28. A direct coupling may include the output shaft of the motor 54 coupled to a hub of the drum 28.

An air system may be provided to the clothes dryer 10. The air system supplies air to the treating chamber 34 and exhausts air from the treating chamber 34. The supplied air may be heated or not. The air system may have an air supply portion that may form, in part, a supply conduit 38, which has one end open to ambient air via a rear vent 37 and another end fluidly coupled to an inlet grill 40, which may be in fluid communication with the treating chamber 34. A heating element 42 may lie within the supply conduit 38 and may be operably coupled to and controlled by the controller 14. If the heating element 42 is turned on, the supplied air will be heated prior to entering the drum 28.

The air system may further include an air exhaust portion that may be formed in part by an exhaust conduit 44. A lint trap 45 may be provided as the inlet from the treating chamber 34 to the exhaust conduit 44. A blower 46 may be fluidly coupled to the exhaust conduit 44. The blower 46 may be operably coupled to and controlled by the controller 14. Operation of the blower 46 draws air into the treating chamber 34 as well as exhausts air from the treating chamber 34 through the exhaust conduit 44. The exhaust conduit 44 may be fluidly coupled with a household exhaust duct (not shown) for exhausting the air from the treating chamber 34 to the outside of the clothes dryer 10.

The air system may further include various sensors and other components, such as a thermistor 47 and a thermostat 48, which may be coupled to the supply conduit 38 in which the heating element 42 may be positioned. The thermistor 47 and the thermostat 48 may be operably coupled to each other. Alternatively, the thermistor 47 may be coupled to the supply conduit 38 at or near to the inlet grill 40. Regardless of its location, the thermistor 47 may be used to aid in determining an inlet temperature. A thermistor 51 and a thermal fuse 49 may be coupled to the exhaust conduit 44, with the thermistor 51 being used to determine an outlet air temperature.

A moisture sensor 50 may be positioned in the interior of the treating chamber 34 to monitor the amount of moisture of the laundry in the treating chamber 34. One example of a moisture sensor 50 is a conductivity strip. The moisture sensor 50 may be operably coupled to the controller 14 such that the controller 14 receives output from the moisture sensor 50. The moisture sensor 50 may be mounted at any location in the interior of the dispensing dryer 10 such that the moisture sensor 50 may be able to accurately sense the moisture content of the laundry. For example, the moisture sensor 50 may be coupled to one of the bulkheads 30, 32 of the drying chamber 34 by any suitable means.

A dispensing system 57 may be provided to the clothes dryer 10 to dispense one or more treating chemistries to the treating chamber 34 according to a cycle of operation. As illustrated, the dispensing system 57 may be located in the interior of the cabinet 12 although other locations are also possible. The dispensing system 57 may be fluidly coupled to a water supply 68. The dispensing system 57 may be further coupled to the treating chamber 34 through one or more nozzles 69. As illustrated, nozzles 69 are provided to the front and rear of the treating chamber 34 to provide the treating chemistry or liquid to the interior of the treating chamber 34, although other configurations are also possible. The number, type and placement of the nozzles 69 are not germane to the invention.

As illustrated, the dispensing system 57 may include a reservoir 60, which may be a cartridge, for a treating chemistry that is releasably coupled to the dispensing system 57, which dispenses the treating chemistry from the reservoir 60 to the treating chamber 34. The reservoir 60 may include one or more cartridges configured to store one or more treating chemistries in the interior of cartridges. A suitable cartridge system may be found in U.S. Pub. No. 2010/0000022 to Hendrickson et al., filed Jul. 1, 2008, entitled “Household Cleaning Appliance with a Dispensing System Operable Between a Single Use Dispensing System and a Bulk Dispensing System,” which is herein incorporated by reference in its entirety.

A mixing chamber 62 may be provided to couple the reservoir 60 to the treating chamber 34 through a supply conduit 63. Pumps such as a metering pump 64 and delivery pump 66 may be provided to the dispensing system 57 to selectively supply a treating chemistry and/or liquid to the treating chamber 34 according to a cycle of operation. The water supply 68 may be fluidly coupled to the mixing chamber 62 to provide water from the water source to the mixing chamber 62. The water supply 68 may include an inlet valve 70 and a water supply conduit 72. It is noted that, instead of water, a different treating chemistry may be provided from the exterior of the clothes dryer 10 to the mixing chamber 62.

The treating chemistry may be any type of aid for treating laundry, non-limiting examples of which include, but are not limited to, water, fabric softeners, sanitizing agents, de-wrinkling or anti-wrinkling agents, and chemicals for imparting desired properties to the laundry, including stain resistance, fragrance (e.g., perfumes), insect repellency, and UV protection.

The dryer 10 may also be provided with a steam generating system 80 which may be separate from the dispensing system 57 or integrated with portions of the dispensing system 57 for dispensing steam and/or liquid to the treating chamber 34 according to a cycle of operation. The steam generating system 80 may include a steam generator 82 fluidly coupled with the water supply 68 through a steam inlet conduit 84. A fluid control valve 85 may be used to control the flow of water from the water supply conduit 72 between the steam generating system 80 and the dispensing system 57. The steam generator 82 may further be fluidly coupled with the one or more supply conduits 63 through a steam supply conduit 86 to deliver steam to the treating chamber 34 through the nozzles 69. Alternatively, the steam generator 82 may be coupled with the treating chamber 34 through one or more conduits and nozzles independently of the dispensing system 57.

The steam generator 82 may be any type of device that converts the supplied liquid to steam. For example, the steam generator 82 may be a tank-type steam generator that stores a volume of liquid and heats the volume of liquid to convert the liquid to steam. Alternatively, the steam generator 82 may be an in-line steam generator that converts the liquid to steam as the liquid flows through the steam generator 82.

It will be understood that the details of the dispensing system 57 and steam generating system 80 are not germane to the embodiments of the invention and that any suitable dispensing system and/or steam generating system may be used with the dryer 10. It is also within the scope of the invention for the dryer 10 to not include a dispensing system or a steam generating system.

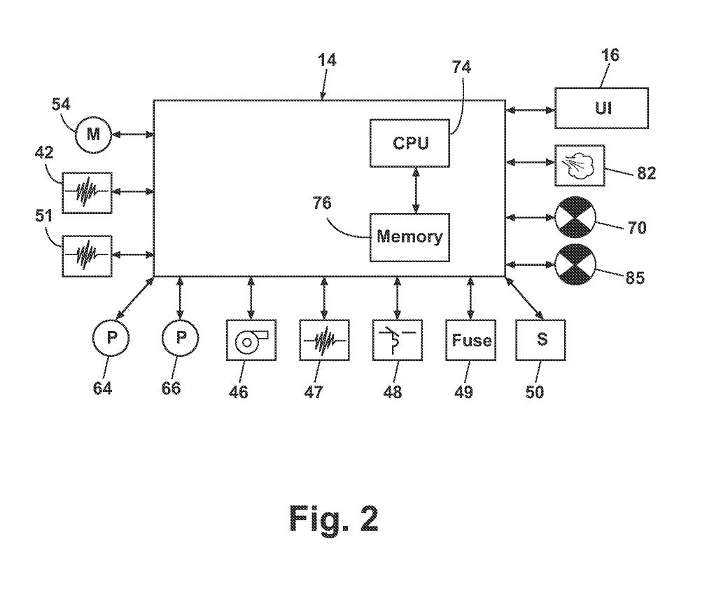

FIG. 2 is a schematic view of the controller 14 coupled to the various components of the dryer 10. The controller 14 may be communicably coupled to components of the clothes dryer 10 such as the heating element 42, blower 46, thermistor 47, thermostat 48, thermal fuse 49, thermistor 51, moisture sensor 50, motor 54, inlet valve 70, pumps 64, 66, steam generator 82 and fluid control valve 85 to either control these components and/or receive their input for use in controlling the components. The controller 14 is also operably coupled to the user interface 16 to receive input from the user through the user interface 16 for the implementation of the drying cycle and provide the user with information regarding the drying cycle.

The user interface 16 may be provided having operational controls such as dials, lights, knobs, levers, buttons, switches, and displays enabling the user to input commands to a controller 14 and receive information about a treatment cycle from components in the clothes dryer 10 or via input by the user through the user interface 16. The user may enter many different types of information, including, without limitation, cycle selection and cycle parameters, such as cycle options. Any suitable cycle may be used. Non-limiting examples include, Casual, Delicate, Super Delicate, Heavy Duty, Normal Dry, Damp Dry, Sanitize, Quick Dry, Timed Dry, and Jeans.

The controller 14 may implement a treatment cycle selected by the user according to any options selected by the user and provide related information to the user. The controller 14 may also comprise a central processing unit (CPU) 74 and an associated memory 76 where various treatment cycles and associated data, such as look-up tables, may be stored. One or more software applications, such as an arrangement of executable commands/instructions may be stored in the memory and executed by the CPU 74 to implement the one or more treatment cycles.

In general, the controller 14 will effect a cycle of operation to effect a treating of the laundry in the treating chamber 34, which may or may not include drying. The controller 14 may actuate the blower 46 to draw an inlet air flow 58 into the supply conduit 38 through the rear vent 37 when air flow is needed for a selected treating cycle. The controller 14 may activate the heating element 42 to heat the inlet air flow 58 as it passes over the heating element 42, with the heated air 59 being supplied to the treating chamber 34. The heated air 59 may be in contact with a laundry load 36 as it passes through the treating chamber 34 on its way to the exhaust conduit 44 to effect a moisture removal of the laundry. The heated air 59 may exit the treating chamber 34, and flow through the blower 46 and the exhaust conduit 44 to the outside of the clothes dryer 10. The controller 14 continues the cycle of operation until completed. If the cycle of operation includes drying, the controller 14 determines when the laundry is dry. The determination of a “dry” load may be made in different ways, but is often based on the moisture content of the laundry, which is typically set by the user based on the selected cycle, an option to the selected cycle, or a user-defined preference.

During a cycle of operation, one or more treating chemistries may be provided to the treating chamber 34 by the dispensing system 57 as actuated by the controller 14. To dispense the treating chemistry, the metering pump 64 is actuated by the controller 14 to pump a predetermined quantity of the treating chemistry stored in the cartridge 60 to the mixing chamber 62, which may be provided as a single charge, multiple charges, or at a predetermined rate, for example. The treating chemistry may be in the form of a gas, liquid, solid, gel or any combination thereof, and may have any chemical composition enabling refreshment, disinfection, whitening, brightening, increased softness, reduced odor, reduced wrinkling, stain repellency or any other desired treatment of the laundry. The treating chemistry may be composed of a single chemical, a mixture of chemicals, or a solution of a solvent, such as water, and one or more chemicals.

The addition of treating chemistry to the treating chamber 34 to treat a load of laundry according to a cycle of operation may result in treating chemistry that is not absorbed by the laundry leaving a residue on the interior surfaces defining the treating chamber 34, such as the door 26, the drum 28 and the front and rear bulkheads 30, 32. The build-up of residue may result in staining or discoloration on the interior surfaces defining the treating chamber 34, which may be visually unappealing to a user and in some cases may also redeposit on laundry in the treating chamber 34. The residue buildup is more apt to occur in a clothes dryer than a clothes washer because the washing cycles of the clothes washer, unlike the drying cycles, tend to remove the residue, such as during a rinse cycle. A clothes dryer is not typically capable of executing a rinse cycle because of the lack of a drain to remove large quantities of liquid. In a clothes dryer, the liquid must be evaporated and cannot be drained. Moreover, the evaporation of the liquids further increases the likelihood that a residue may remain.

Staining or discoloration of the interior surfaces defining the treating chamber 34 may come from a variety of different sources and may vary depending on the material forming the interior surfaces that define the treating chamber 34. For example, staining or discoloration may be the result of residue left behind by the treating chemistry applied by the dispensing system 57, water added to the treating chamber 34 by the dispensing system 57, steam generator 82 and/or the laundry, organic material carried by the laundry and accidental consumer staining (e.g. a pen or crayon accidentally placed in the dryer).

Some of the residue is attributable to normal operation such as hard water residue on a stainless steel drum, which may result in rainbow-like streaking or discoloration of the drum. For example, the addition of water to the treating chamber 34, either by the dispensing system 57 or steam generator 82 or from some other source, such as the laundry, may result in the build-up of mineral deposits on the interior surfaces defining the treating chamber 34. Water supplied from a municipal water supply or a well typically contains minerals, such as calcium, magnesium, iron, manganese and silicates, for example, which may leave behind a residue within the treating chamber 34. This residue may lead to discoloration of the interior surfaces defining the treating chamber 34, which may make the interior surfaces visually unappealing and a cause of concern for the user.

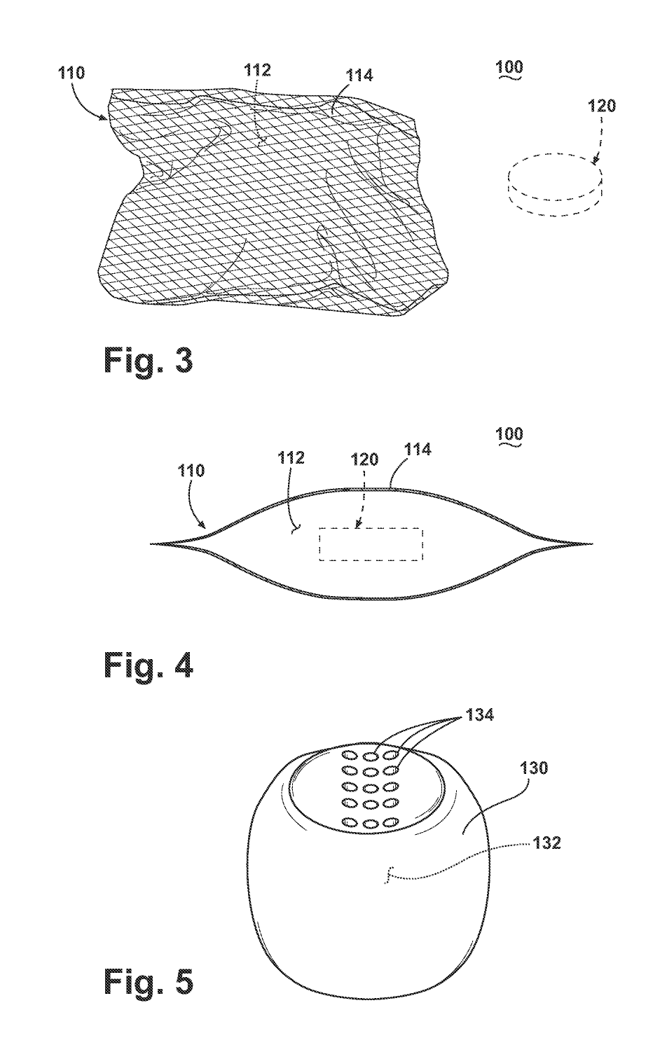

FIG. 3 illustrates a treating packet 100 for removing residue from the interior surfaces defining the treating chamber 34. The treating packet 100 may include a pouch 110 and a chemical insert 120. The pouch 110 has an interior 112 configured to receive the chemical insert 120 and an exterior or outer surface 114. The pouch 110 may be made from any suitable porous material, such as a fabric, laminate or membrane. For example, the pouch 110 may be made from a woven or non-woven polymeric material, such as polyester, nylon, polyamide, polyvinyl acetate or polyethylene fibers or microfiber or combinations thereof. The pouch 110 may also be made from natural materials, such as cotton, or a combination of natural and synthetic materials. The exterior surface 114 of the pouch 110 may also be texturized to facilitate removal of residue from the interior surfaces defining the treating chamber 34. The pouch 110 may also be absorbent such that the pouch 110 absorbs residue and liquid which comes into contact with the pouch 110.

As illustrated in FIG. 3, the pouch 110 may be in the form of a mesh bag. While the pouch 110 is illustrated as having a generally rectangular shape, it is within the scope of the invention for the pouch 110 to have any polygonal shape, such as oval, circular and square, for example, and to have any suitable dimensions.

The chemical insert 120 may be in solid, liquid, gel, pellet, flake, powder, tablet or granular form and may include one or more components or mixtures of components. The component or components of the chemical insert 120 may be selected depending on the nature of the stain or discoloration to be treated. For example, to treat stains and discoloration as a result of minerals present in water or corrosion, the chemical insert 120 may include one or more strong or weak inorganic or organic acids or mixtures of acids. Non-limiting examples of acids suitable for use with the treating packet 100 include citric acid, lactic acid, acetic acid, ascorbic acid, sorbic acid, muriatic acid, formic acid, phosphoric acid, oxalic acid, gluconic acid, glycolic acid, succinic acid, adipic acid and sulfamic acid, methylglycinediacetic acid, nitriloacetic acid, ethylenediaminetetraactic acid, diethylenetriaminepentaacetic acid, hydroxyethylethylenediaminetriacetic acid, 1,3-propylenediamine tetraacetic acid. For example, citric acid and methylglycinediacetic acid may be used to remove residue as a result of calcium and magnesium carbonates, which are typically present in hard water. In another example, oxalic acid may be used to remove residue as a result of iron oxide that may be present in water supplied to the treating chamber 34. An example of an exemplary chemical insert 120 includes citric acid and oxalic acid to remove both hard water residue and iron oxide residue from the interior surfaces defining the treating chamber 34.

The chemical insert 120 may also include one or more organic solvents, non-limiting examples of which include terpenes, such as d-limonene, propylene glycol, glycol ethers, ethers, alkoxy-propanols, ketones, amines, amides, siloxanes, polyols, alcohols, dibasic esters, fatty acid esters, branched and linear hydrocarbons, hydroxycarboxylic acid and glycol ether esters. Non-limiting examples of glycol ethers includes, propylene glycol methyl ether, dipropylene glycol methyl ether, tripropylene glycol methyl ether, propylene glycol butyl ether, dipropylene glycol butyl ether, propylene glycol propyl ether, dipropylene glycol propyl ether, ethylene glycol butyl ether, diethylene glycol butyl ether, ethylene glycol hexyl ether, ethylene glycol phenyl ether, hydroxycarboxylic acids and propylene glycol phenyl ether. Examples of commercially available glycol ethers include the DOWANOL™, CELLUSOLVE™, CARBITOL™ and ECOSOFT™ series of glycol ethers available from The Dow Chemical Company. Non-limiting examples of ketones include methyl ethyl ketone, acetone, diisobutyl ketone, methyl isobutyl ketone, isobutyl heptyl ketone and isoacetopherone. Non-limiting examples of alcohols include isopropyl alcohol, ethanol, branched and linear alcohols. Non-limiting examples of dibasic esters include dimethyl succinate, dimethyl glutarate, dimethyl adipate, diisobutyl succinate, diisobutyl glutarate and diisobutyl adipate. Non-limiting examples of fatty acid esters include soy methyl ester and i-propyl myristate. An example of a suitable hydroxycarboxylic acid includes ethyl hexyl lactate. Another example of a suitable solvent includes 1,1,1-trichloroethylene. The type and amount of organic solvent included in the chemical insert 120 may be selected to meet safety requirements for use in a dryer where heated air may or may not be used.

The chemical insert 120 may also include one or more oxidizing agents. Non-limiting examples of suitable oxidizing agents include bleach, bleach generating compounds, peroxide compounds and peroxide generating compounds. An example of a suitable peroxide compound is hydrogen peroxide.

The chemical insert 120 may also include a component that is catalyzed or activated by a chemical carried by the pouch 110. For example, the pouch 110 may include a bleach or peroxide activating compound and the chemical insert 120 may include the corresponding bleach or peroxide which is activated upon reaction with the activating compound in the pouch 110. It is also within the scope of the invention for the chemical insert 120 to include the catalyst or activator and the pouch 110 to carry the corresponding component that is activated by the catalyst or activator.

The chemical insert 120 may also include one or more chelating agents, such as EDTA, biocidal agents, surfactants, polymeric binders, effervescent agents, buffers and fragrances. The one or more surfactants may include an anionic, cationic, nonionic or amphoteric surfactant or combinations thereof. The biocidal agent may include any component or mixture of components that kills, destroys or inactivates microorganisms such as bacteria, mites, spores, and fungi, or infectious agents such as viruses and prions, for example. An effervescent agent is a component or mixture of components which is designed to generate a gas upon reaction with another component. For example, the reaction of citric acid with sodium bicarbonate generates carbon dioxide gas which may mix with an aqueous solution to generate a foam.

In one example, the chemical insert 120 may include citric acid and the pouch 110 may include sodium bicarbonate. Reaction of the citric acid with the sodium bicarbonate in the pouch 110 in the presence of water generates carbon dioxide gas resulting in an effervescent or foamed chemical solution, which may facilitate cleaning of the interior surfaces defining the treating chamber 34.

The chemical insert 120 may be provided in a concentrated form such that when the chemical insert 120 is dissolved or mixed with liquid, the resultant diluted chemical solution has a pH of approximately 1-6. The chemical insert 120 may be formed such that when the chemical insert 120 is dissolved or mixed with liquid, the active components, for example the one or more acids, has a concentration range of approximately 0.00001 to 1.0 mole/L. Alternatively, the chemical insert 120 may be provided in a non-concentrated form having a pH of approximately 1-6 and concentration range of the active components of approximately 0.00001 to 1.0 mole/L without dilution.

Referring now to FIG. 4, the pouch 110 may be configured to removably or irremovably receive the chemical insert 120 within the interior 112 of the pouch 110. In one example, the chemical insert 120 may be provided in the pouch 110 and the pouch 110 may be sealed using one or more mechanical fasteners, such as stitching, or non-mechanical fasteners, such as an adhesive or weld, such that the chemical insert 120 is not removable from the pouch 110. In this manner the treating packet 100 may be provided to a user as a single use packet.

Alternatively, the pouch 110 may be provided with a reclosable opening (not shown) through which the chemical insert 120 may be inserted or removed. The opening may be provided with one or more fasteners, such as one or more snaps, buttons, zippers, a draw string or hook and loop tape, for example, which may be used to selectively provide access to the interior 112 of the pouch 110. In this manner, the pouch 110 may be refillable and reusable with a chemical insert 120 such that the treating packet 100 may be used multiple times by a user.

The chemical insert 120 may be directly provided to the interior 112 of the pouch 110 as illustrated in FIG. 4. Alternatively, the chemical insert 120 may be provided within a storage package which may be placed within the interior 112 of the pouch 110. FIG. 5 illustrates one example of a storage package for the chemical insert 120 in the form of a hollow casing 130 having an interior space 132 for receiving and storing the chemical insert 120. The hollow casing 130 may have a plurality of apertures 134 fluidly coupled with the interior space 132 and the chemical insert 120 stored therein. The hollow casing 130 may be provided with a selectively reclosable opening (not shown) such that the hollow casing 130 may be refilled with the chemical insert 120 and reused. Alternatively, the hollow casing 130 may be configured so as not to be refillable and reusable. The hollow casing 130 may be made from any suitable synthetic or natural elastomeric material such as polybutadiene or natural rubber, for example.

In another example, the chemical insert 120 may be provided within a storage package in the form of a water soluble casing which dissolves upon contact with water, releasing the chemical insert 120 into the interior 112 of the pouch 110. An example of a water soluble casing includes polyvinyl alcohol or polyvinyl acetate. In yet another example, the storage package may be in the form of a mesh bag.

In yet another example, the pouch 110 may be formed with the chemical insert 120 pre-impregnated within the material forming the pouch 110.

The chemical insert 120 may be configured, whether provided directly to the interior 112 of the pouch 110, provided to the interior 112 within a storage package or pre-impregnated within the pouch 110, to form a chemical solution when exposed to liquid. The chemical solution formed when the chemical insert 120 is exposed to liquid may be absorbed by the pouch 110 to the exterior surface 114 of the pouch 110 where it may then be applied to the interior surfaces defining the treating chamber 34 during a cycle of operation.

The previously described clothes dryer 10 and treating packet 100 provides the structure necessary for the implementation of the method of the invention. Embodiments of the method will now be described in terms of the operation of the clothes dryer 10. The embodiments of the method function to treat staining and discoloration from the interior surfaces defining the treating chamber 34.

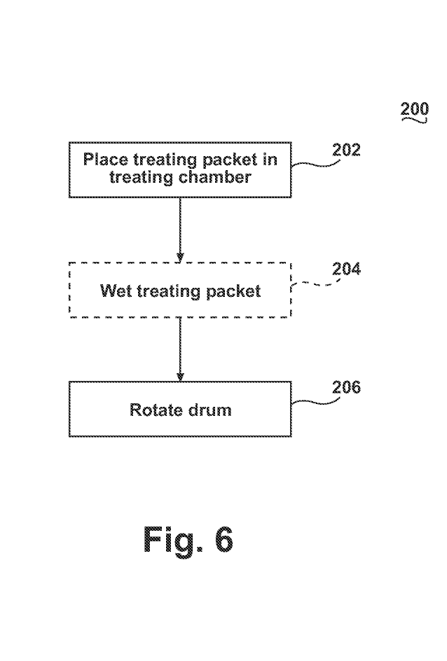

FIG. 6 is a flow-chart depicting a method 200 of removing staining and discoloration from the interior surfaces defining the treating chamber 34 according to an embodiment of the invention. The method 200 may be carried out by the controller 14 using information inputted by the user via the user interface 16. The method 200 described herein may be implemented as an independent cycle or as part of another cycle of operation. The sequence of steps depicted is for illustrative purposes only and is not meant to limit the method 200 in any way as it is understood that the steps may proceed in a different logical order, additional or intervening steps may be included, or described steps may be divided into multiple steps, without detracting from the invention.

The method 200 begins at 202 with placing the treating packet 100 having a chemical insert 120 located within the pouch 110 within the treating chamber 34 without laundry in the treating chamber 34. The treating packet 100 may be placed within the treating chamber 34 prior to or after the user selects a cycle of operation. The treating packet 100 may be provided to the user pre-assembled, i.e. with the chemical insert 120 located within the pouch 110, such as in the case of a single use treating packet 100, for example. Alternatively, in the case of a multiple use treating packet 100, the user may first place the chemical insert 120 inside the pouch 110 prior to placing the treating packet 100 in the treating chamber 34.

Optionally, at 204 the treating packet 100 may be automatically wetted by liquid applied to the treating chamber 34 as part of the selected cycle of operation or manually wetted by the user. The liquid may be supplied by the dispensing system 57 or the steam generator 82 as a spray, stream, mist, aerosol or droplets to the treating chamber 34 to wet the treating packet 100. Alternatively, the steam generator 82 may apply liquid in gaseous form as steam to the treating chamber 34 to wet the treating packet 100. In one exemplary method, the dispensing system 57 provides liquid to the treating chamber 34 at an injection rate of approximately 20-60 mL/min.

Alternatively, the treating packet 100 may be manually wetted by the user. Manually wetting the treating packet 100 by the user may occur prior to the user placing the treating packet 100 in the treating chamber 34 at 202. In another example, the user may provide the treating packet 100 and a measured amount of liquid to the treating chamber 34. For example, the user may add the treating packet 100 to the treating chamber 34 along with approximately 4 ounces (approximately 118 mL or about ½ cup) of liquid.

The treating packet 100 may be configured such that when liquid is applied to the treating packet 100, either manually by a user or automatically by the clothes dryer 10, the liquid interacts with the chemical insert 120 to form a chemical solution that may be applied by the exterior 114 of the pouch 110 to the interior surfaces defining the treating chamber 34. The amount of liquid applied to the treating packet 100, either manually or automatically, may be selected depending on the components of the chemical insert 120 to provide a chemical solution having a predetermined pH and concentration.

It is within the scope of the invention for the treating packet 100 to be extrinsically wetted, intrinsically wetted or not wetted. Non-limiting examples of extrinsically wetted include manual wetting by a user or automatic wetting by the clothes dryer 10. Non-limiting examples of intrinsically wetted include wetting by a liquid carried by the treating packet 100 or absorbing moisture from the environment.

At 206, the drum 28 may be rotated to move the treating packet 100 within the treating chamber 34. In the case of a wetted treating packet, rotation of the drum 28 at 206 may contribute to the interaction of the liquid with the chemical insert 120 and the subsequent absorption of the formed chemical solution by the exterior 114 of the pouch 110. The liquid used to wet the treating packet 100 may be water or any other liquid which may include additional components. If the treating packet 100 is being used as part of a pre-programmed cycle designed for use with the treating packet 100, the dispensing system 57 or the steam generator 82 may be programmed to supply a predetermined amount of liquid to the treating packet 100 such that the chemical solution formed when the liquid interacts with the chemical insert 120 has a predetermined pH and concentration. Alternatively, if the treating packet 100 is being used with a cycle of operation designed for treating laundry, the chemical insert 120 may be configured to form the predetermined chemical solution based on the amount of liquid added to the treating chamber 34 during the cycle of operation.

The drum 28 may be rotated at 206 to move the treating packet 100 within the treating chamber 34 to facilitate interaction of the treating packet 100 with the interior surfaces defining the treating chamber 34. The drum 28 may be rotated randomly or rotated according to a preprogrammed cycle of operation. The size and weight of the treating packet 100 and the rotation of the drum 28 may be configured to work together synergistically to treat the interior surfaces defining the treating chamber 34. For example, the treating packet 100 may have a width and a length of approximately 5-40 cm and a weight of approximately 1-100 grams. In one example, the drum 28 may be controlled so as to tumble the treating packet 100 within the drum 28 such that the exterior 114 of the pouch 110 interacts with the interior surfaces of the treating chamber 34 with sufficient force so as to abrade residue present on the interior surfaces of the treating chamber 34.

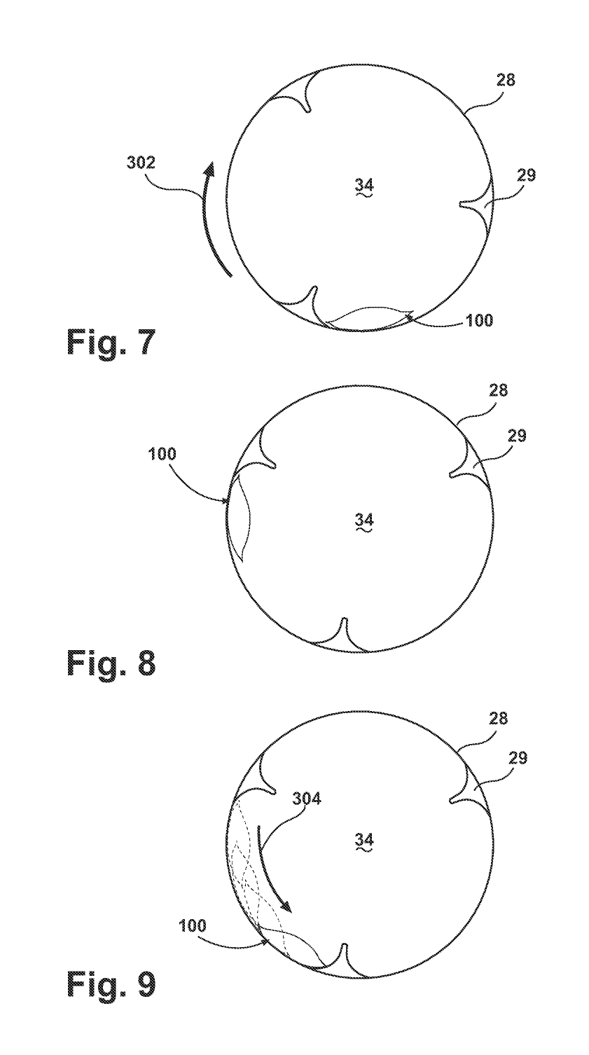

FIGS. 7-9 illustrate a method of controlling the drum 28 such that the treating packet 100 slides down or wipes the interior surface of the drum. As illustrated in FIG. 7, the drum 28 may be rotated as indicated by arrow 302 to lift the treating packet 100 from a location near a bottom of the treating chamber 34 to some height above the bottom of the treating chamber 34, as illustrated in FIG. 8. The rotation of the drum 28 is then stopped such that the treating packet 100 slides down the interior surface of the drum 28 from the lifted position illustrated in FIG. 8 to a location near the bottom of the treating chamber 34, as illustrated by arrow 304 in FIG. 9.

As the treating packet 100 is lifted within the treating chamber 34 to a height above the bottom of the treating chamber 34, as illustrated in FIG. 8, the treating packet 100 gains potential energy. As the treating packet 100 slides down the interior surface of the drum 28 when the rotation of the drum 28 ceases, as illustrated in FIG. 9, the treating packet 100 releases at least some of its stored potential energy. The process of rotating the drum 28 and ceasing the rotation of the drum 28 may occur multiple times and the direction, speed and time of rotation may be varied to facilitate contact of the treating packet 100 with the interior surface of the drum 28.

As the treating packet 100 slides down the interior surface of the drum 28, releasing at least some of its stored potential energy, the exterior 114 of the pouch 110 abrades residue that may be present on the interior surface of the drum 28 which the exterior 114 of the pouch 110 comes into contact with. The chemical solution formed during the wetting of the chemical insert 120 and present on the exterior 114 of the pouch 110 may react with the residue present on the interior surface of the drum 28 to at least partially solubilize the residue such that the residue may be absorbed by the pouch 110. The mechanical cleaning action from the abrasion of the interior surface of the drum 28 by the exterior 114 of the pouch 110 and the chemical cleaning action from the reaction of the chemical solution with the residue may act synergistically to remove stains and discoloration from the interior surfaces defining the treating chamber 34. The residue which is mechanically and/or chemically removed from the interior surfaces defining the treating chamber 34 and the chemical solution may be reabsorbed by the treating packet 100 for removal from the treating chamber 34.

Another example of a suitable method for controlling the rotation of the drum 28 is described in U.S. Pub. No. 2010/0000115 to Chernetski et al., filed Jun. 23, 2009, entitled “Method for Removing Chemistry Buildup in a Dispensing Dryer,” which is herein incorporated by reference in full. As disclosed in U.S. Pub. No. 2010/0000115 to Chernetski et al., the rotational direction and speed of the drum may be varied such that an article within the treating chamber repeatedly detaches from the drum and falls within the drum to form multiple trajectories relative to the front and rear bulkheads. Varying the rotational direction and speed provides multiple trajectories which collectively span the front and rear bulkheads. As the treating packet 100 travels the multiple trajectories, the front and rear bulkheads 30, 32 and the door 26 are wiped by the treating packet 100. In this manner, both an interior surface of the drum 28 and the front and rear bulkheads 30, 32 and door 26 may be wiped by the treating packet 100.

In yet another example, the drum 28 may be rotated such that the treating packet 100 moves within the treating chamber 34 in a random pattern. For example, the drum 28 may be rotated in a first direction for 1 to 3 minutes with a dwell time of 2 seconds and rotated in a second direction opposite the first direction for 1 to 3 minutes with a dwell time of 2 seconds. An exemplary speed of rotation of the drum 28 is 40-45 rpm, although it is within the scope of the invention for the drum 28 to be rotated at any suitable speed, such as 30-50 rpm, for example. In this manner, the treating packet 100 may move randomly within the treating chamber 34 to contact and treat the surfaces defining the treating chamber 34.

The weight of the treating packet 100 may be configured such that when the treating packet 100 is moved within the treating chamber 34 during rotation of the drum 28, contact of the exterior surface 114 with residue present on the interior surfaces defining the treating chamber 34 abrades the residue such that it may be absorbed by the treating packet 100 and removed. The combined weight of the pouch 110, chemical insert 120 and liquid absorbed by the pouch 110 and/or chemical insert 120 when wetted may be selected so as to provide the desired abrasion force.

During rotation of the drum 28, the blower 46 may be activated such that the airflow rate through the treating chamber 34 ranges from 0-160 cubic feet per minute. It is also within the scope of the invention for the blower 46 to be inactivated during rotation of the drum 28 with the treating packet 100. An exemplary airflow rate for use with the treating packet 100 is 80-120 cubic feet per minute.

Thermal energy may or may not be provided to the treating chamber 34 during rotation of the drum 28 with the treating packet 100 to heat the treating chamber 34 and/or treating packet 100. Thermal energy may be applied in the form of heated air through activation of the heating element 42 or steam from the steam generator 82. The temperature within the treating chamber 34 may range from ambient to 160° C. In one example, thermal energy may be applied to the treating packet 100 to activate one or more components of the chemical insert 120 or to facilitate the cleaning action of the chemical solution formed by the wetting of the treating packet 100. For example, thermal energy may be applied to activate temperature sensitive oxygen-based bleaches, such as hydrogen peroxide and sodium percarbonate. The chemical insert 120 may also include chemical activators, such as tetra-acetylethylenediamine (TAED) and hydrophobic esters of oxy benzene sulfonate, to activate oxygen-based bleaches alone or in combination with thermal energy.

While the method 200 for using the treating packet 100 is described in the context of an empty drum 28 in which no laundry is present, it is also within the scope of the invention for the treating packet 100 to be used when laundry is present in the drum 28. The presence of laundry within the drum 28 may reduce the rate of interaction between the treating packet 100 and the interior surfaces defining the treating chamber 34 and/or increase the time necessary to treat the interior surfaces of the treating chamber 34.

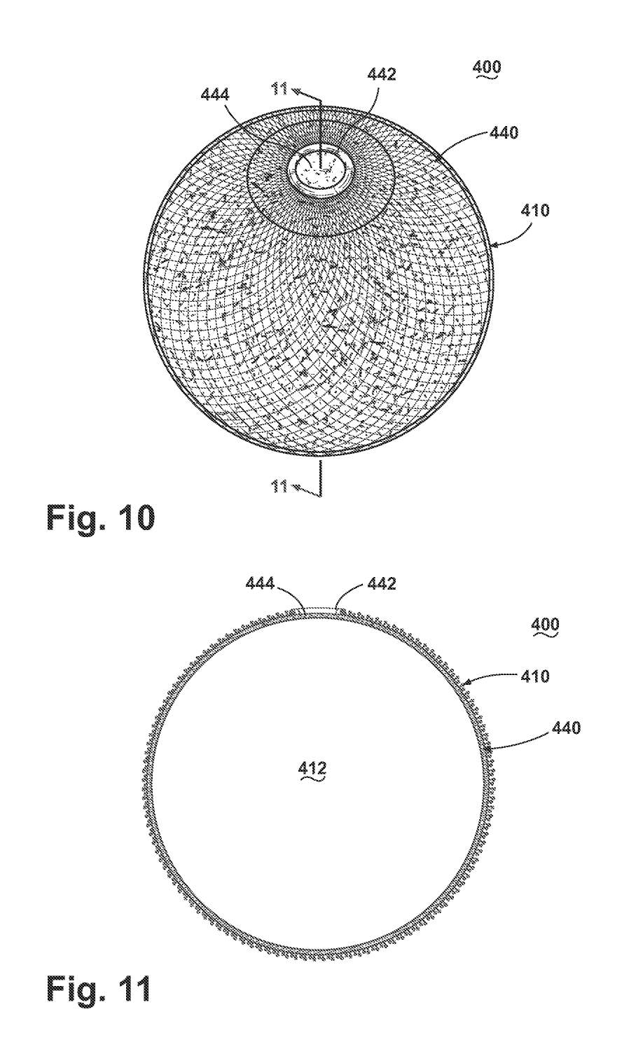

FIG. 10 illustrates a treating packet 400 similar to the treating packet 100 except for a support 440. Therefore, elements of the treating packet 400 similar to those of the treating packet 100 will be labeled with the prefix 400. The treating packet 400 may be used to treat the interior surfaces defining the treating chamber 34 in a manner similar to that described above for the treating packet 100 using the method 200 of FIG. 6 or according to any other method.

The treating packet 400 includes a pouch 410 which may be configured to at least partially encompass and surround the support 440. The pouch 410 may be provided with an elastic band 442 that may be stretched to pull the pouch 410 over the support 440, but resiliently returns to an unstretched condition to secure the pouch 410 around the support 440 as illustrated in FIG. 10. It is also within the scope of the invention for the pouch 410 to be secured around the support 440 using any suitable type of retaining device. Non-limiting examples of suitable retaining devices include hook and loop tape, an adhesive, snaps, buttons, a drawstring and one or more elastomeric retainers having slits in a spoke-like pattern that form deformable flaps for holding a portion of the pouch 410. An example of such a retainer is disclosed in U.S. Pat. No. 3,099,855 to Nash which is incorporated herein by reference in its entirety.

The pouch 410 may be made from a woven or non-woven polymeric material, such as polyester, nylon, polyamide, polyvinyl acetate or polyethylene fibers or microfiber or combinations thereof. The pouch 410 may also be made from natural materials, such as cotton, or a combination of natural and synthetic materials. An exterior surface of the pouch 410 may also be texturized to facilitate removal of residue from the interior surfaces defining the treating chamber 34.

Referring now to FIG. 11, the support 440 may be made from any suitable polymeric material such as plastic or natural or synthetic rubber. The support 440 may include a removable cap 444 for selectively providing access to the interior chamber 412 of the support 440. It is also within the scope of the invention for the support 440 to not include the cap 444 and/or to have a solid interior. An exemplary support 440 has a Shore durometer hardness of 20-90, a diameter of 2-20 cm and a density of 0.2-1.5 grams/cc.

In one example, the pouch 410 may be configured as a single use pouch that is disposed of by the user after use and may be impregnated with a chemical insert in the form of one or more chemicals for treating the interior surfaces defining the treating chamber 34. The pouch 410 may be provided to the user pre-wetted or may be manually or automatically wetted according to the method 200 of FIG. 6. According to one example, multiple pouches 410 may be provided to the user stored within the interior chamber 412 of the support 440. Before use, the user may remove the cap 444, withdraw a pouch 410 stored within and place the pouch 410 around the support 440 as described above. The assembled treating packet 400 may then be used to treat the interior surfaces defining the treating chamber 34 according to the method 200 of FIG. 6, for example.

In another example, the pouch 410 may be configured as a reusable pouch that a user may use repeatedly to treat the interior surfaces defining the treating chamber 34. The support 440 may be made from a porous material such that a chemical insert in the form of a chemical solution stored within the interior chamber 412 may flow out of the interior chamber 412 and wet the pouch 410 encompassing the support 440. According to this example, the treating packet 400 may be provided to the user with the chemical insert already present within the interior chamber 412 or the user may add the chemical insert to the interior chamber 412 prior to use. Alternatively, the chemical insert may be provided in the form of a solid, liquid or gel which forms a chemical solution upon wetting of the treating packet 400.

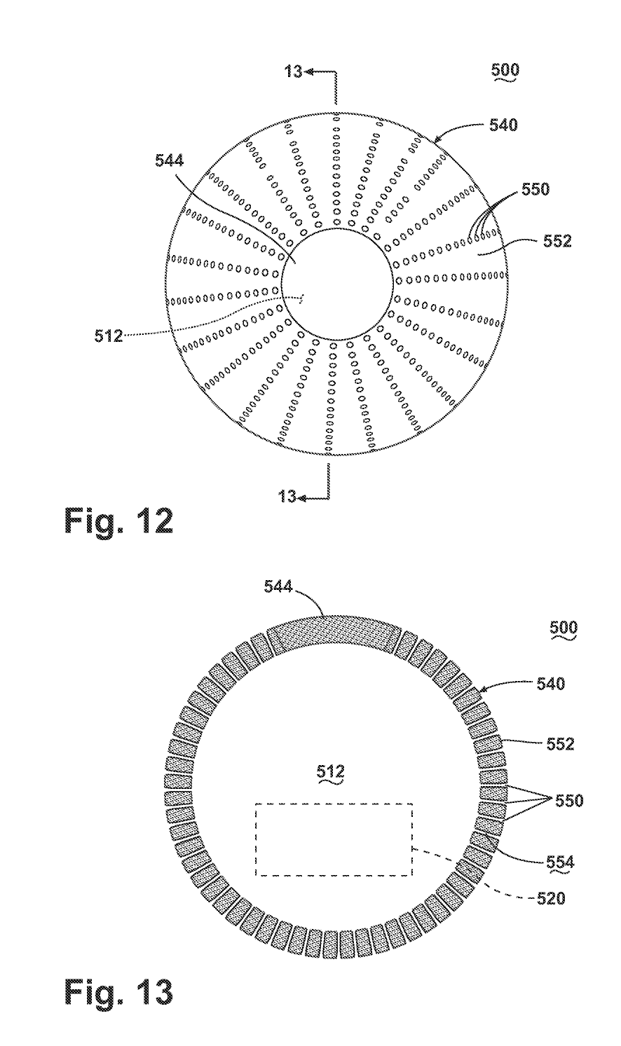

FIG. 12 illustrates a treating packet 500 similar to the treating packet 400 except for the structure of a support 540. Therefore, elements of the treating packet 500 similar to those of the treating packet 400 will be labeled with the prefix 500. The treating packet 500 may be used to treat the interior surfaces defining the treating chamber 34 in a manner similar to that described above for the treating packets 100 and 400 using the method 200 of FIG. 6 or according to any other method.

The support 540 may include a removable cap 544 for selectively providing access to an interior chamber 512 of the support 540. The support 540 may also be provided with one or more apertures 550 on an exterior surface 552 of the support 540.

Referring now to FIG. 13, the apertures 550 may be fluidly coupled with the interior chamber 512 of the support 540 through channels 554. In this manner, material provided within the interior chamber 512 may flow out through the channels 554 to the exterior surface 552 of the support 540.

A chemical insert 520 may be provided within the interior chamber 512 in the form of a liquid, solid or gel. The chemical insert 520 may be provided as a pre-diluted chemical solution which may be added to the interior chamber 512 by the user or may be provided within the interior chamber 512 prior to purchase by the user. Alternatively, the chemical insert 512 may be a concentrated liquid, solid or gel that is diluted by liquid applied to the treating packet 500 to form a diluted chemical solution. Liquid may be applied to the treating packet 500 by wetting the treating packet 500 according to any of the methods described above for the treating packets 100 and 400. The diluted chemical solution may be in the form of a liquid, gel or foam.

In one example, the exterior surface 552 of the support 540 may be absorbent such that the chemical solution flowing out through the channels 554 is absorbed by the exterior surface 552 and may subsequently be applied to the interior surfaces defining the treating chamber 34 during use. Additionally or alternatively, the chemical solution flowing out through the channels 554 may be applied directly to the interior surfaces defining the treating chamber 34. The exterior surface 552 may also be texturized to facilitate abrasion of the residue that comes into contact with the treating packet 500. The exterior surface 552 may also be configured to absorb the abraded residue and applied chemical solution.

In another example, the support 540 may be provided with a pouch similar to the pouch 410 described above with respect to FIGS. 10 and 11. In this manner, the chemical solution flowing out through the channels 554 may be absorbed by the pouch and subsequently applied to the interior surfaces defining the treating chamber 34 during use. The support 540 and/or the pouch may be configured as single use items or reusable items.

The treating packets described herein may be used to treat the interior surfaces defining the treating chamber to remove residue and staining that may provide the interior surfaces defining the treating chamber with a visually unappealing appearance and/or may also undesirably transfer to the laundry in the treating chamber 34 during use. The treating packets may be provided to the treating chamber and the drum may be rotated according to a predetermined cycle of operation to facilitate contact of the treating packet with the various interior surfaces defining the treating chamber with enough mechanical force to abrade the stains and residue present on the interior surfaces, thus providing the treating packet with mechanical cleaning action. The treating packet may also be provided with a chemical solution to provide the treating packet with chemical cleaning action to facilitate the removal of stains and residue. The combination of mechanical cleaning action and chemical cleaning action may act synergistically to facilitate removal of stains and residue from the interior surfaces defining the treating chamber.

While the invention has been specifically described in connection with certain specific embodiments thereof, it is to be understood that this is by way of illustration and not of limitation, and the scope of the appended claims should be construed as broadly as the prior art will permit. It should also be noted that all elements of all of the claims may be combined with each other in any possible combination, even if the combinations have not been expressly claimed.

What is claimed is:

1. A treating packet for treating the inner surface of a rotatable drum in a laundry treating appliance, comprising:
a chemical insert comprising at least one water-soluble chemical; and
a permeable pouch enveloping the chemical insert and having a textured exterior surface;
wherein the weight of the chemical insert and the permeable pouch in combination with the textured exterior surface apply a mechanical cleaning force sufficient to abrade a residue, which is chemically-reactive to the water-soluble chemical, on the inner surface during rotation of the drum.

2. The treating packet of claim 1 wherein the textured exterior surface holds a chemical solution formed by water permeating the pouch and at least partially dissolving the at least one water-soluble chemical.

3. The treating packet of claim 1 wherein the pouch encapsulates the chemical insert.

4. The treating packet of claim 1 wherein the pouch and chemical insert are at least one of: co-molded, co-extruded, chemically bonded, or adhesively bonded.

5. The treating packet of claim 1 wherein the pouch comprises at least one of: woven fabric, non-woven fabric, non-woven polymeric fibers, polyvinyl acetate, polyethylene fibers, microfiber, or nylon.

6. The treating packet of claim 1 wherein the chemical insert comprises at least one of: citric acid, lactic acid, acetic acid, ascorbic acid, sorbic acid, muriatic acid, formic acid, phosphoric acid, oxalic acid, gluconic acid, glycolic acid, succinic acid, adipic acid, sulfamic acid, methylglycinediacetic acid, nitriloacetic acid, ethylenediaminetetraactic acid, diethylenetriaminepentaacetic acid, hydroxyethylethylenediaminetriacetic acid, 1,3-propylenediamine tetraacetic acid, a chelating agent, a biocide agent or combinations thereof

7. The treating packet of claim 6 wherein a chemical solution formed by water permeating the pouch and at least partially dissolving the at least one water-soluble chemical has a pH of approximately 1-6.

8. The treating packet of claim 1 wherein the chemical insert comprises at least one of: a solid, a gel, a liquid, granules, a powder, flakes, pellets or a tablet.

9. The treating packet of claim 8 wherein the chemical insert is encapsulated within a water-soluble shell.

10. The treating packet of claim 1 wherein the pouch comprises a porous mesh fabric and the chemical insert comprises at least one acid selected from citric acid or oxalic acid.

11. The treating packet of claim 10 wherein the at least one acid is encased within a hollow casing having a plurality of apertures and the hollow casing is placed inside the pouch.

12. The treating packet of claim 11 wherein the hollow casing is refillable with the at least one acid.

13. The treating packet of claim 1 wherein the chemical insert comprises one or more organic solvents.

14. The treating packet of claim 13 wherein the organic solvent includes at least one of terpenes, propylene glycol, glycol ethers, ethers, alkoxy-propanols, ketones, amines, amides, siloxanes, polyols, alcohols, dibasic esters, fatty acid esters, branched and linear hydrocarbons, hydroxycarboxylic acid or glycol ether esters.

15. The treating packet of claim 1 wherein one of the pouch and the chemical insert comprises at least one component configured to react with at least one component carried by the other of the pouch and the chemical insert.

16. The treating packet of claim 15 wherein one of the pouch and the chemical insert comprises an oxidizing agent and the other of the pouch and the chemical insert comprises an oxidizing agent activator.

17. The treating packet of claim 16 wherein the oxidizing agent comprises one of bleach or a peroxide compound.

18. The treating packet of claim 15 wherein one of the pouch and the chemical insert comprises an effervescent agent configured to react with at least one component carried by the other of the pouch and the chemical insert to generate a gas.
